(19) United States
(12) Patent Application Publication
(10) Pub. No.: US 2026/0129021 A1
(43) Pub. Date: May 7, 2026

(54) ARTIFICIAL INTELLIGENCE ASSISTED CONFIGURATION COMPLIANCE POLICY CREATION AND ENFORCEMENT FRAMEWORK

(71) Applicant: Palo Alto Networks, Inc., Santa Clara, CA (US)

(72) Inventors: Prem Kumar Jayaraj, Sunnyvale, CA (US); Chadd Jeffrey Christiansen, New Port Richey, FL (US); Vishwas Tantry, Fremont, CA (US); Miaomiao Shen, Los Gatos, CA (US); Zezhou Chen, Santa Clara, CA (US)

(21) Appl. No.: 18/940,460

(22) Filed: Nov. 7, 2024

(51) Int. Cl. H04L 9/40; G06F 16/21; G06F 16/25; G06F 16/3329

(52) U.S. Cl. CPC H04L 63/02; G06F 16/211; G06F 16/258; G06F 16/3329

(57) ABSTRACT

A natural language description of a custom configuration for a firewall is received. A prompt is generated based on the natural language description. The prompt includes a schema. A large language model response that includes verification logic for the firewall based on the schema is received. The verification logic is stored in a database.

### BACKGROUND OF THE INVENTION

A network firewall is associated with a default configuration that includes one or more rules. Each rule is associated with a default value (or an industry-defined best practice value for that rule or fields in a rule or any network configuration object). For example, a rule may indicate that a particular port has a default value of “value 1.” These default values may align with industry best practices to ensure the network secured by the firewall remains protected. However, a customer may desire to implement a custom configuration that modifies some or all of the default values associated with the one or more rules (or industry-defined best practice value for a field). The network firewall may be updated to implement the custom firewall configuration. As a result, one or more security vulnerabilities may be introduced into the customer's network.

### BRIEF DESCRIPTION OF THE DRAWINGS

Various embodiments of the invention are disclosed in the following detailed description and the accompanying drawings.

FIG. 1 is a block diagram illustrating a system to generate a verification logic for a custom firewall configuration and apply the verification logic to a modification to the custom firewall configuration in accordance with some embodiments.

FIG. 2 is a flow diagram illustrating a process to generate a verification logic for a custom firewall configuration in accordance with some embodiments.

FIG. 3 is a flow diagram illustrating a process to verify a custom configuration modification to a configuration file in accordance with some embodiments.

FIG. 4A illustrates an example of a prompt in accordance with some embodiments.

FIG. 4B illustrates an example of the verification logic generated by a large language model in accordance with some embodiments.

FIG. 5A illustrates an example of a prompt in accordance with some embodiments.

FIG. 5B illustrates an example of the verification logic generated by a large language model in accordance with some embodiments.

FIG. 6 illustrates an example of a metaschema.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A security provider associated with the firewall may provide default settings for a firewall. An administrator of a network associated with a firewall may desire to implement a firewall configuration with settings that differ from the default settings established by the security provider. Currently, a software engineer is needed to generate a custom firewall configuration. A software engineering team currently maintains a library in Python or other code which maintains the industry-defined best practice values for all the fields of the firewall configuration. The code may be written in Python, which can be challenging to maintain and requires a dedicated team for ongoing support. The software engineer may not be a subject matter expert on best practices for a network firewall. The python or other code library runs when a customer makes any configuration changes on their firewall. However, the library cannot support customer specific best practices. A generic framework is needed which can solve both industry-defined and customer defined best practices without any code change needed every time a new configuration is introduced or a new best practice needs to be created for some configuration object.

When the custom firewall configuration is implemented in production, its settings may be modified at any time. However, the modification(s) may inadvertently introduce one or more security vulnerabilities into the network. The systems and methods disclosed herein enable a subject matter expert to define a custom configuration policy for their network firewall to prevent one or more security vulnerabilities from being introduced into the network without the need for a software engineer to explicitly write the code. The systems and methods disclosed herein not only allows the subject matter expert to specify values for rules associated with the custom firewall configuration, but also allows verification logic to be generated to prevent the modification(s) from introducing the one or more security vulnerabilities into the network.

The systems and methods disclosed herein enable a user to specify values for rules associated with the custom firewall configuration via a machine learning service. The user interacts with the machine learning service via a client device (e.g., laptop, desktop, tablet, smartphone, etc.). The machine learning service may have a conversational interaction with the user. For example, the machine learning service may ask the user a series of questions about the custom firewall configuration. The machine learning service may generate a prompt based on a natural language processing of the one or more user responses. In some embodiments, the user provides a prompt. The prompt is provided to a large language model (LLM). The LLM may be a public LLM, a public LLM, or a hybrid LLM.

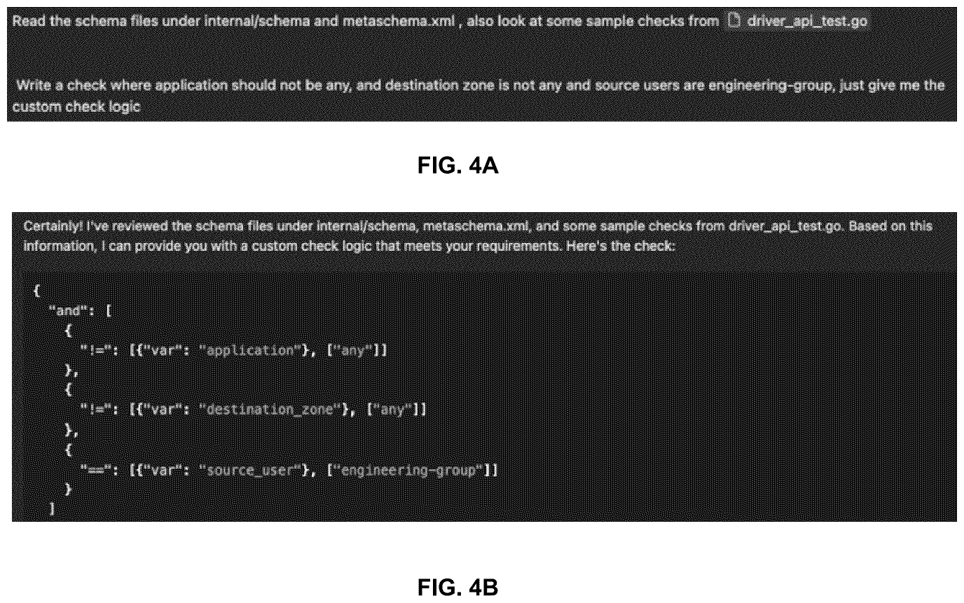

FIG. 4A illustrates an example of a prompt. The instruction is “[w]rite a check where application should not be any, and destination zone is not any and source users are engineering-group, just give me the custom check logic.”

The schema ensures that any object validated against it must follow the defined structure, helping to ensure data consistency and integrity. The schema for the custom configuration may be provided in any format. For example, the schema is written in JSON. In some embodiments, a schema is converted from a first format (e.g., XML) into a second format (e.g., JSON). This enables the systems and methods disclosed herein to be scalable for any type of firewall system.

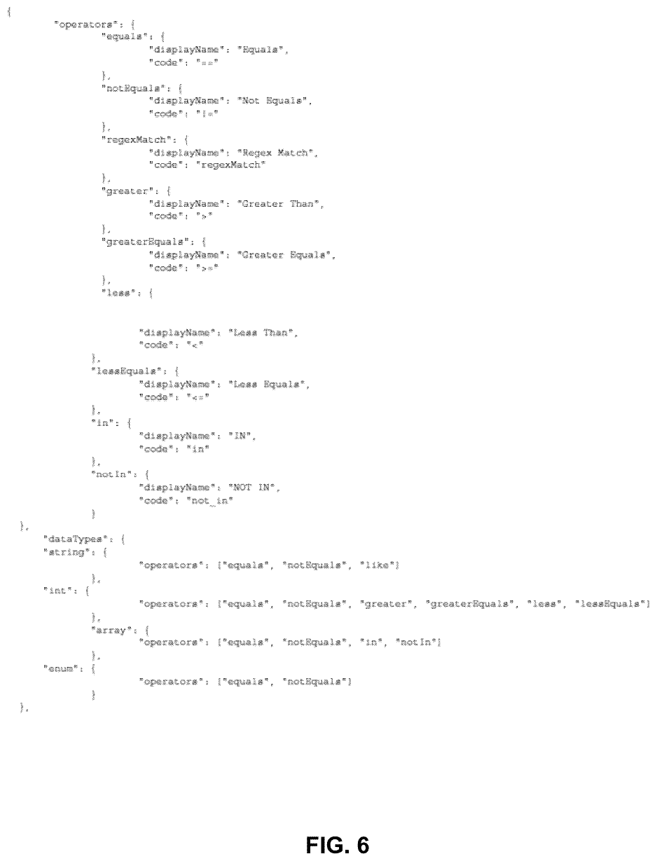

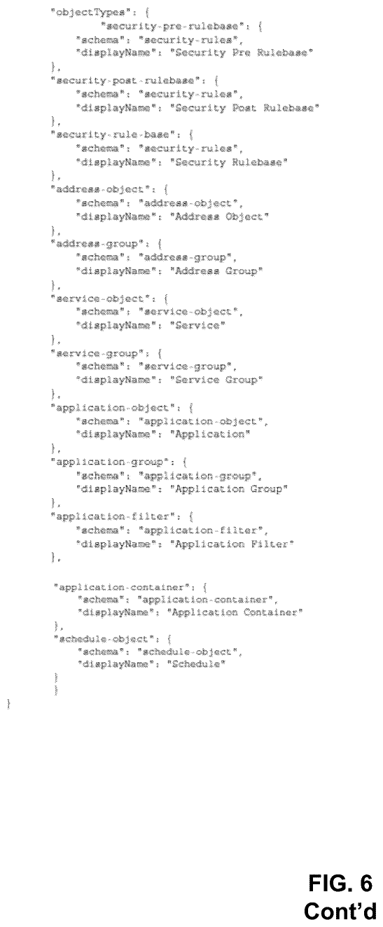

The user interface and backend are driven by the metaschema. The metaschema defines one or more supported operator types (e.g., equals, not equals, greater than, in, notin), one or more supported data types (e.g., int, string, Boolean, array), one or more data type supported operators (e.g., int data type supports following operators equals, not equals, greater), and one or more object types. FIG. 6 illustrates an example of a metaschema.

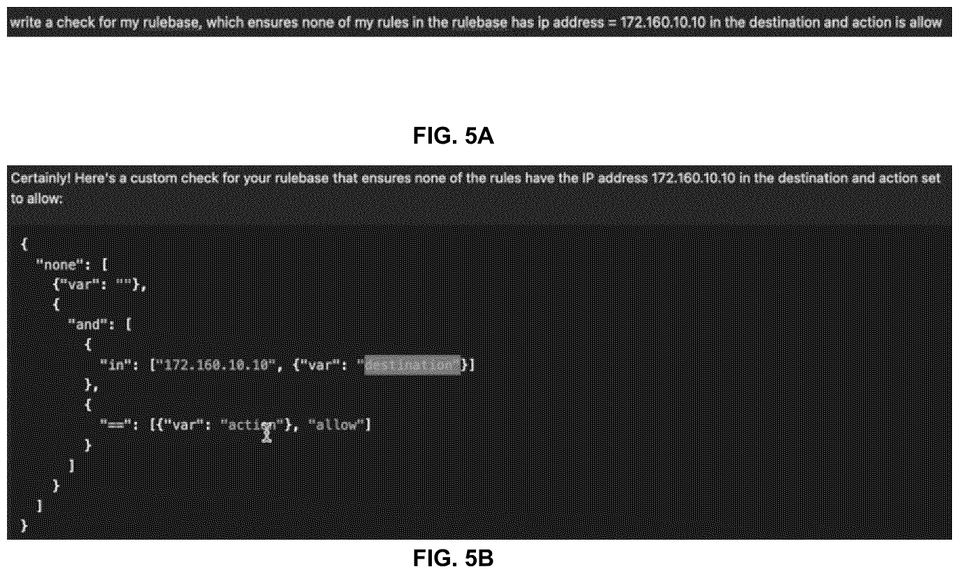

FIG. 5A illustrates another example of a prompt. The instruction is “write a check for my rulebase, which ensures none of my rules in the rulebase has ip address=172.160.10.10 in the destination and action is allow.”

In response to receiving the prompt, the LLM analyzes the prompt to identify the schema and operators. The LLM generates the verification logic to enforce the rules associated with the custom configuration. The verification logic includes one or more checks that are created from the identified schema and operators. FIG. 4B illustrates an example of the verification logic generated by the LLM in response to the prompt illustrated in FIG. 4A. FIG. 5B illustrates an example of the verification logic generated by the LLM in response to the prompt illustrated in FIG. 5A. The machine learning service stores the verification logic in a database for one or more subsequent validity checks.

When a modification to the custom firewall configuration is detected, a best practice assessor obtains the verification logic from the database and applies the verification logic to the custom firewall configuration modification. In some embodiments, there are no errors in the custom firewall configuration modification, the modification(s) are permitted, and the network firewall configuration is modified. In some embodiments, there are one or more errors in the custom firewall configuration modification, the modification to the custom firewall configuration is denied, and the network firewall maintains its current set of values for different fields.

The best practice assessor generates a report based on an evaluation of the custom firewall configuration modification with respect to the verification logic. The report is provided to a user (e.g., the user attempting to modify the custom configuration, an administrator associated with the firewall, etc.).

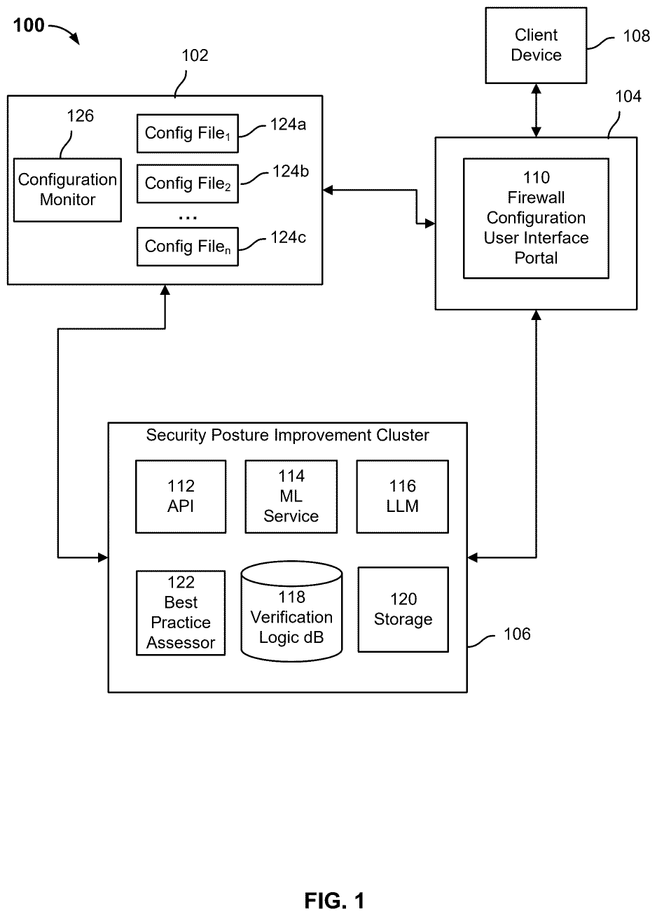

FIG. 1 is a block diagram illustrating a system to generate a verification logic for a custom firewall configuration and apply the verification logic to a modification to the custom firewall configuration in accordance with some embodiments. In the example shown, system 100 includes cluster 102, cluster 104, and cluster 106. Although system 100 depicts cluster 102, cluster 104, and cluster 106 as distinct clusters, cluster 102, cluster 104, and cluster 106 may be combined into one or more clusters. In some embodiments, cluster 102, cluster 104, and cluster 106 are cloud clusters. In some embodiments, cluster 102, cluster 104, and cluster 106 are on-prem clusters. In some embodiments, cluster 102, cluster 104, and cluster 106 are hybrid clusters.

A user associated with a client device 108 communicates with firewall configuration user interface portal 110 hosted on cluster 104. Client device 108 may be a server, a computer, a desktop, a laptop, a tablet, a smartphone, or any other computing device with Internet access. Firewall configuration user interface portal 110 is configured to enable a user, such as an administrator, to generate a custom configuration for a firewall. In some embodiments, the custom configuration is generated based on a natural language input received from the user via client device 108. In some embodiments, the custom configuration is generated based on code received from the user via client device 108.

Firewall configuration user interface portal 110 is configured to enable a user to modify the custom firewall configuration. In some embodiments, the one or more modifications are made via a natural language input received from the user via client device 108. In some embodiments, the one or more modifications are made via a user interface that displays a plurality of fields associated with the firewall and their corresponding values. The user may attempt to modify any of the plurality of fields and their corresponding values via the firewall configuration user interface portal 110.

Firewall configuration user interface portal 110 is configured to enable a user to specify one or more requirements for the firewall. Cluster 106 includes applications programming interface 112 that enables the user to have a conversational interaction with machine learning service 114 via firewall configuration user interface portal 110. Firewall configuration user interface portal 110 sends one or more API requests to application programming interface 112 based on the user input. The user input may include one or more example schemas, an example sample check, and/or an instruction. The schema for a custom firewall configuration may be provided in any format. For example, the schema is written in JSON. In some embodiments, ML service 114 converts the schema from a first format (e.g., XML) into a second format (e.g., JSON). This enables the systems and methods disclosed herein to be scalable for any type of firewall system.

In response to the one or more API requests, machine learning service 114 is configured to generate a prompt and provide the prompt to LLM 116. Based on the user input, the machine learning service is configured to generate a prompt for LLM 116. LLM 116 analyzes the prompt to identify the schema and operators. LLM 116 generates the verification logic to enforce the rules associated with the custom firewall configuration. The verification logic includes one or more checks that are created from the identified schema and operators. LLM 116 stores the verification logic in verification logic database 118 for one or more subsequent validity checks. Verification logic database 118 is configured to store verification logic for a plurality of different tenants.

Cluster 102 is configured to store a plurality of firewall configuration files for a plurality of different tenants. Each configuration file 124a, 124b, . . . , 124n is associated with a firewall of a particular tenant. Configuration monitor 126 is configured to detect whether there has been a changed to any of the configuration files 124a, 124b, . . . , 124n associated with any of the tenants. Configuration monitor 126 is configured to check the configuration files 124a, 124b, . . . 124n according to a schedule (e.g., every minute, every five minutes, every 10 minutes, etc.).

In response to detecting a change to a configuration file associated with a tenant, configuration monitor 126 is configured to provide the modified configuration file to storage 120 and configured to provide a notification to best practice assessor 122. The modified configuration file is stored as a temporary file until being verified by best practice assessor 122. In some embodiments, the configuration file associated with the tenant is a JSON file, an XML file, or any other type of file that stores a firewall configuration. In some embodiments, configuration monitor 126 compresses the configuration file before storing the configuration file in storage 120.

In response to receiving the notification, best practice assessor 122 is configured to obtain the modified configuration file from storage 120 and the verification logic file corresponding to the tenant from verification logic database 118. In some embodiments, best practice assessor 122 converts the configuration file associated with the tenant into a format associated with the verification logic file corresponding to the tenant. For example, configuration file associated with the tenant may be converted from XML to JSON.

Best practice assessor 122 is configured to apply the one or more checks included in the verification logic file to the modified configuration file associated with the tenant. In some embodiments, best practice assessor 122 determines that the modified configuration file associated with the tenant does not include any errors. In response to a determination that the configuration file associated with the tenant does not include one or more errors, best practice assessor 122 sends a notification to configuration monitor 126 that the modified configuration file associated with the tenant does not include one or more errors. In response, configuration monitor 126 stores the modified version configuration file associated with the tenant as a verified version of the configuration file. The firewall associated with the tenant utilizes the verified version of the configuration file in its decision making processes.

In some embodiments, best practice assessor 122 determines that the modified configuration file associated with the tenant includes one or more errors. In response to a determination that the configuration file associated with the tenant includes one or more errors, best practice assessor 122 sends a notification to configuration monitor 126 that the modified configuration file associated with the tenant includes one or more errors. In response, configuration monitor 126 reverts the configuration file associated with the tenant to a previously verified version of the configuration file.

Best practice assessor 122 generates a report indicating the reasons why the modified configuration file associated with the tenant did or did not pass the verification check and stores the report in storage 120. A user associated with the tenant may access the stored report via firewall configuration user interface portal 110.

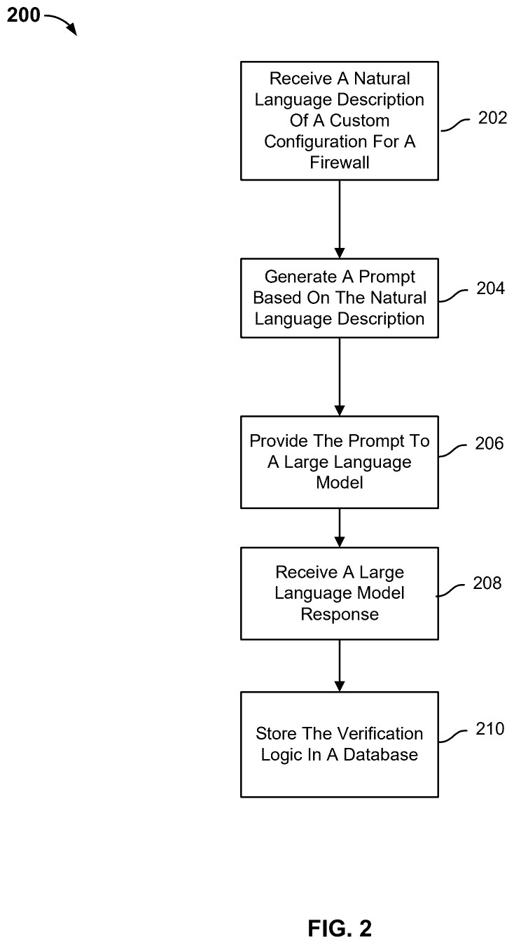

FIG. 2 is a flow diagram illustrating a process to generate a verification logic for a custom firewall configuration in accordance with some embodiments. In the example shown, process 200 may be implemented by a machine learning service, such as machine learning service 114.

At 202, a natural language description of a custom configuration for a firewall is received. A user interacts with a machine learning service via a client device. The machine learning service may have a conversational interaction with the user. For example, the machine learning service may ask the user a series of questions about the custom configuration. The user may provide, via the client device, one or more example schemas, an example check, and instructions.

At 204, a prompt based on the natural language description is generated. The machine learning service may analyze the conversational interaction with the user using a natural language processing algorithm to identify one or more keywords. The generated prompt may include the one or more identified keywords, the one or more example schemas, the example check, and the instruction. In some embodiments, the one or more examples schemas are converted from a first format into a second format.

At 206, the prompt is provided to a LLM to create verification logic for the firewall's custom configuration.

At 208, a LLM response is received. The LLM response includes the logic to verify any modifications to the firewall custom configuration. In some embodiments, the verification logic is written in a format that matches the provided schema. In some embodiments, the verification logic is written in a format that is different than the provided schema.

At 210, the verification logic is stored in a database.

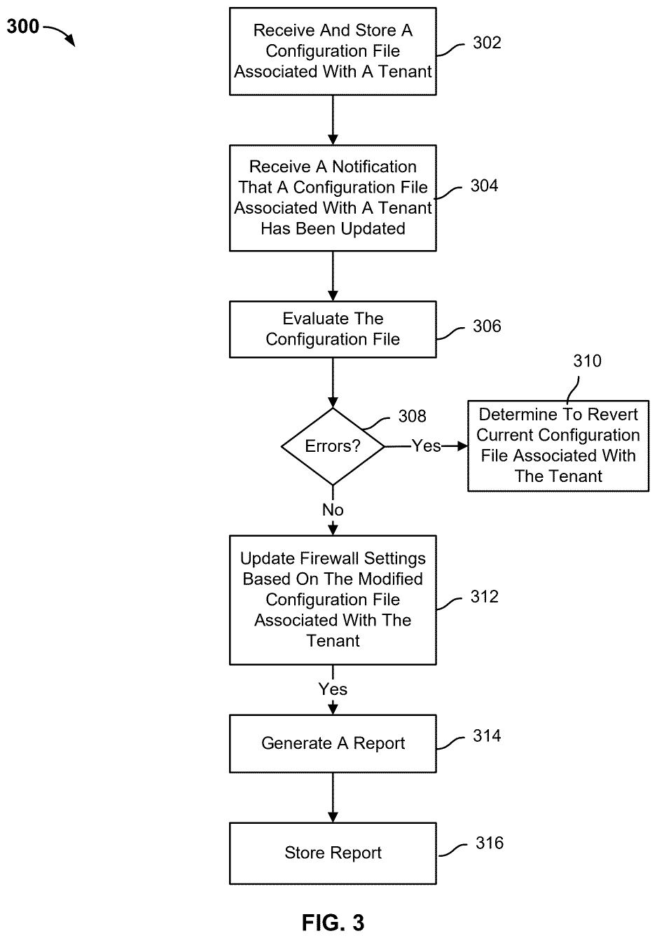

FIG. 3 is a flow diagram illustrating a process to verify a custom configuration modification to a configuration file in accordance with some embodiments. In the example shown, process 200 may be implemented by a best practice assessor, such as best practice assessor 122.

At 302, a configuration file associated with a tenant is received and stored in a storage. The configuration files associated with a plurality of tenants are stored in a configuration cluster. A configuration monitor is configured to detect whether there has been a changed to any of the configuration files associated with any of the tenants. In response to detecting a change to a configuration file associated with a tenant, the configuration monitor provides the modified configuration file to a storage associated with a best practice assessor. In some embodiments, the configuration file associated with the tenant is a JSON file. In some embodiments, the configuration file associated with the tenant is an XML file. The received configuration file associated with the tenant may be a compressed version of the configuration file associated with the tenant.

At 304, a notification that a configuration file associated with a tenant has been updated is received. The configuration monitor may check the configuration file associated with the tenant according to a schedule (e.g., every minute, every five minutes, every 10 minutes, etc.). In response to detecting a change to a configuration file associated with a tenant, the configuration monitor provides to a best practice assessor the notification that a configuration file associated with a tenant has been updated the modified configuration file to a storage associated with the best practice assessor.

At 306, the configuration file associated with the tenant is evaluated. A database stores a plurality of verification logic files for a plurality of different tenants. The best practice assessor obtains from the database a verification logic file corresponding to the tenant and obtains the configuration file associated with the tenant from storage. In some embodiments, the best practice assessor converts the configuration file associated with the tenant into a format associated with the verification logic file corresponding to the tenant. For example, a configuration file associated with the tenant may be converted from XML to JSON.

The one or more checks included in the verification logic file are applied to the configuration file associated with the tenant.

At 308, it is determined whether the configuration file associated with the tenant includes any errors. In response to a determination that the configuration file associated with the tenant includes one or more errors, process 300 proceeds to 310. In response to a determination that the configuration file associated with the tenant does not include any errors, process 300 proceeds to 312.

At 310, it is determined that the current configuration file associated with the tenant should be reverted back to a previously verified version of the configuration file. In some embodiments, the previously verified version of the configuration file is the most recent verified version of the configuration file. In some embodiments, the previously verified version of the configuration file is a verified version of the configuration file that is not the most received verified version.

At 312, firewall settings are updated based on the modified configuration file associated with the tenant. The best practice assessor sends a notification to a configuration monitor that the modified configuration file associated with the tenant does not include one or more errors. In response, the configuration monitor stores the modified version configuration file associated with the tenant as a verified version of the configuration file. The firewall associated with the tenant utilizes the verified version of the configuration file in its decision making processes.

At 314, a report is generated. The report indicates whether the one or more modifications to the configuration file associated with the tenant produced any errors. The report also indicates the point in time in which there were any errors with the configuration file.

At 316, the report is stored. The stored report may be accessible by a user via a firewall configuration user interface portal.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a natural language description of a custom configuration for a firewall;
generating a prompt based on the natural language description, wherein the prompt includes a schema;
receiving a large language model response that includes verification logic for the firewall based on the schema; and
storing the verification logic in a database.

2. The method of claim 1, wherein the schema is converted from a first format into a second format.

3. The method of claim 2, wherein the first format is XML and the second format is JSON.

4. The method of claim 1, wherein the verification logic is written in a format that matches a format associated with the schema.

5. The method of claim 1, wherein the natural language description is determined from a conversational interaction between a user and a machine learning service.

6. The method of claim 1, further comprising receiving a modified configuration file associated with the firewall.

7. The method of claim 6, further comprising receiving a notification that a configuration file associated with the firewall has been modified.

8. The method of claim 7, wherein the modified configuration file associated with the firewall is associated with a particular tenant.

9. The method of claim 8, determining that the verification logic stored in the database corresponds to the particular tenant.

10. The method of claim 9, further comprising obtaining the modified configuration file associated with the firewall and the verification logic corresponding to the particular tenant.

11. The method of claim 10, further comprising applying the verification logic corresponding to the particular tenant to the modified configuration file associated with the firewall.

12. The method of claim 11, further comprising determining to revert the modified configuration file associated with the firewall to a previous version of a custom configuration file for the file in response to determining that there are one or more errors associated with the modified configuration file.

13. The method of claim 12, wherein the previous version is a most recent verified version of the custom configuration file.

14. The method of claim 11, further comprising updating firewall settings for the firewall based on the modified configuration file in response to determining that there are no errors associated with the modified configuration file.

15. The method of claim 11, further comprising generating a report based on applying the verification logic corresponding to the particular tenant to the modified configuration file associated with the firewall.

16. A system, comprising:
a processor configured to:
receive a natural language description of a custom configuration for a firewall;
generate a prompt based on the natural language description, wherein the prompt includes a schema;
receive a large language model response that includes verification logic for the firewall based on the schema; and
store the verification logic in a database; and
a memory coupled to the processor and configured to provide the processor with instructions.

17. The system of claim 16, wherein the schema is converted from a first format into a second format.

18. The system of claim 16, wherein the verification logic is written in a format that matches a format associated with the schema.

19. The system of claim 16, wherein the natural language description is determined from a conversational interaction between a user and a machine learning service.

20. A computer program product embodied in a non-transitory computer readable medium and comprising computer instructions for:
receiving a natural language description of a custom configuration for a firewall;
generating a prompt based on the natural language description, wherein the prompt includes a schema;
receiving a large language model response that includes verification logic for the firewall based on the schema; and
storing the verification logic in a database.
